(19) United States
(12) Patent Application Publication
(10) Pub. No.: US 2006/0281053 A1
(43) Pub. Date: Dec. 14, 2006

(54) Mannequin head sensor

(76) Inventor: Rochelle Rosalind Medcalf, Chicago, IL (US)

Correspondence Address: Rochelle Rosalind Medcalf, 7634 S. ADA #2, Chicago, IL, 60620, US

(21) Appl. No.: 11/096,120

(22) Filed: Jun. 13, 2005

(51) Int. Cl. G09B 19/10

(52) U.S. Cl. 434/94

(57) ABSTRACT

The electrical wire connections under the mannequin head is the main ingredient that makes the student perfected in the skill of curling the hair properly without touching the scalp. The wiring is connected throughout the scalp so wherever the curling iron touches the mannequins scalp this will alert the instructor and when the instructor reads the print out it will state how many times and where on the scalp the iron touched the scalp and the instructor can help the student more efficiently. An educational device with electronic outputs that are new and makes an improved mannequin head that is a leaning aide as well as an electronic device. For beauty schools to use universally through out the world.

The Mannequin Head sensor is an educational device used for students, such as cosmetology students learning how to curl hair without burning the scalp. The electrical sensors will give the instructors a digital printed read-out of 80 degree heat temperature when the curling irons touch the scalp of the mannequin head. This will give the student a sense of timing on heat when they are learning to curl hair. This will enable the student to curl hair correctly without burning the scalp or the hair.

FIG. I

The front side view of the Mannequin Head sensor. The electrical sensor points will start an electrical wire connection from the top front of the head and will stop at the bottom in the back of the head. The electrical sensor will be hidden so that the student can curl with out being conscious of the wire connections.

FIG. II

The left side view of the Mannequin Head Sensor. The electrical sensor points will also start an electrical wire connection from the top left side to the top right side. Connections will continue down to the back bottom of the back of the mannequin head The right side will mirror identical connections.

FIG. III

The back view of the Mannequin Head Sensor. The connections of the sections hooked from side to side, front to back are labeled wirings coded in alphabet letters for the LCD wiring and the bottom box is the ground of digital print out

In conclusion, the entire mannequin head has connections of wiring all through out the head to give an electronic read out to the instructor for the purpose of informing the student of the errors made while curling the hair and burning the scalp. Which will make the student more proficient in the cosmetology field.

FIG. IV

The electrical and electronic breadboard lay out. This shows the connections between the electrical and electronic printouts that informs the instructor of the errors being made by the students. The connections are how the digital and physical printouts win be established through the wiring and the destination of placement for the electronic wiring.

Specification Sheet

I, have invented a new design called “The Mannequin head Sensor” as set forth in the following specification:

Cross-Reference to prior related application to nonprovisional and international applications filed pending A reply to 37 CFR 1.75, 1.126, 1.75 please refer to the last pages that are underlined pages 12-14

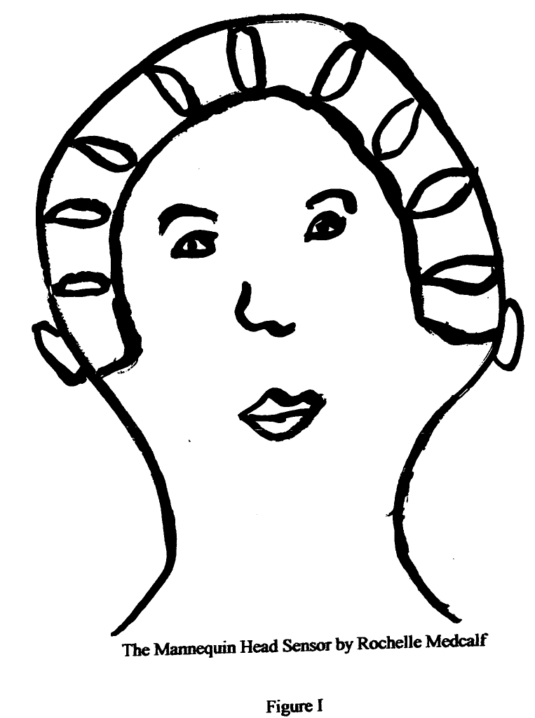

FIG. 1 is a front view of a mannequin showing my new design and the wiring connections. This will allow the instructor to see any of the errors being made through out the mannequin head.

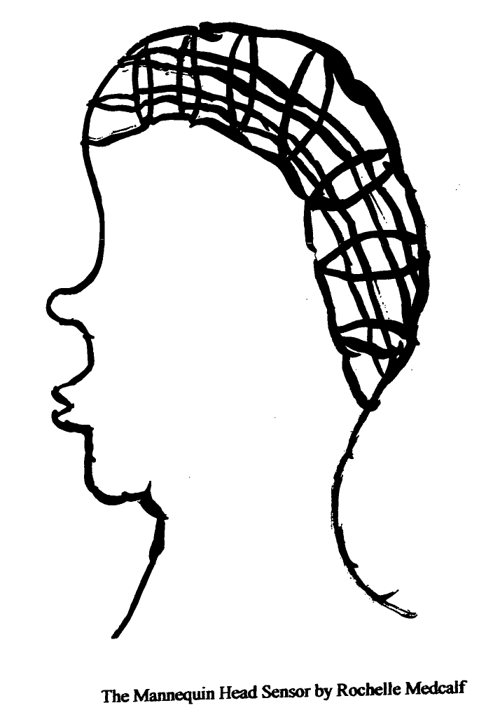

FIG. 2 is a left view of the mannequin head showing wiring connections by alphabet labels to show the LCD wiring connection. The right side mirrors the left side. Which can show the instructor on the sides of the head where the curling iron will have touched the scalp.

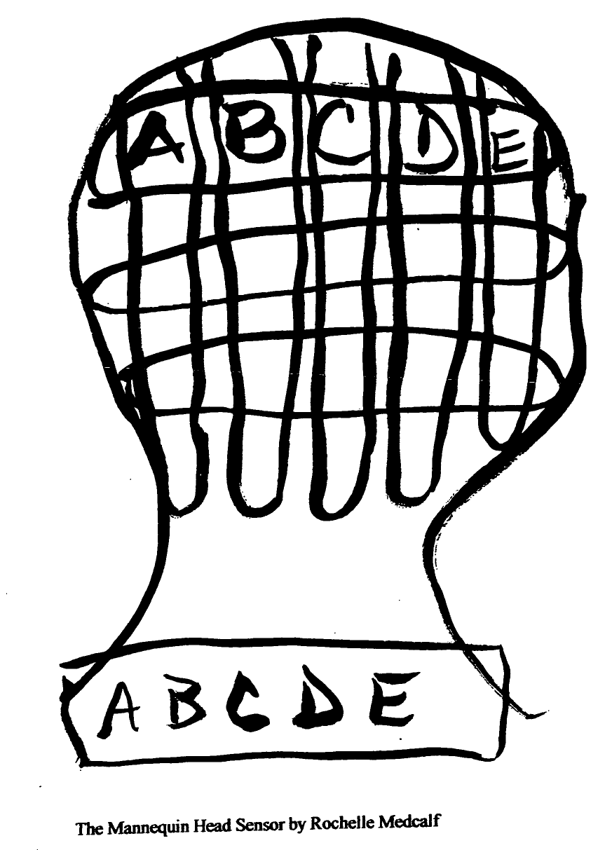

FIG.3 is a back view of the mannequin head showing the alphabetical label connections of the entire back of the mannequin head connections. Which can also show the instructor where the curling will have touched the scalp.

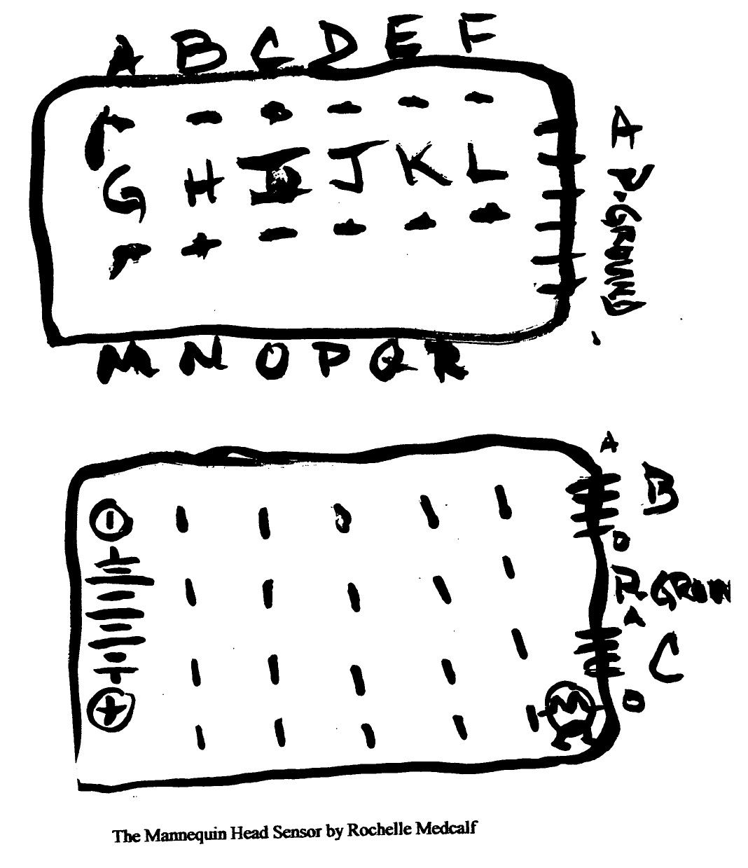

FIG.4 is a view of the circuit board that will enable the electronic operation to perform what the “Mannequin Head Sensor” was invented to do, which is to display the number of times a person touches the scalp of the mannequin head and where on the mannequin head he/she will have touched the scalp.

I claim: The Ornamental design and the purpose of the invention of the “Mannequin Head Sensor” as shown in the figures, this informs the instructor of any problems that the student has in his/her skills of curling hair properly, also a student learning how to curl hair will learn how to curl hair without burning the scalp with the practice on the Mannequin Senor Head.

History

For year's beauty schools have used mannequins for learning practice tools to teach students how to roller set, style hair, some chemical applications and haircuts. The idea of the Mannequin Head Sensor is to be a learning tool but on a higher level of learning to aide teachers and students because of the feed back of informing teachers of the errors being made by the student. Which is the digital readout.

1. I claim an educational device comprised of an oval shaped head mannequin which has an electronic wiring connection.

2. I claim the mannequin head of claim one along with the electronic wiring that gives a digital print out of the number of number of touches from the student whom will be using the mannequin head to learn how to cud hair without burning the scalp.

3. I claim the electronic wiring that gives a digital print out of claim two along with the electrical wiring that is connected to the base scalp of the mannequin head to aide in the showing of a physical output as well as the digital output.

4. I claim the design of the invention and how it was invented to help students learn how to curl hair properly without burning the scalp, it was thought of long ago when I was 19 yrs. old when I thought of the “Mannequin Head Sensor” and I stand by it for the educational purpose of all students learning how to curl hair without burning the scalp for the development of all learning how to curl hair.
